(19) United States
(12) Patent Application Publication
(10) Pub. No.: US 2008/0005399 A1
(43) Pub. Date: Jan. 3, 2008

(54) Method and Apparatus for Determining the Status of Bus Requests and Responses

(75) Inventors: Andrew E. Gruber, Arlington, MA (US); Mark Grossman, Palo Alto, CA (US)

Correspondence Address: ADVANCED MICRO DEVICES, INC.;C/O VEDDER PRICE KAUFMAN & KAMMHOLZ, P.C., 222 N.LASALLE STREET, CHICAGO, IL, 60601, US

(73) Assignee: ATI Technologies Inc., Markham (CA)

(21) Appl. No.: 11/383,611

(22) Filed: May 16, 2006

(51) Int. Cl. G06F 3/00

(52) U.S. Cl. 710/42

(57) ABSTRACT

Command handling logic receives a plurality of command requests and groups the plurality of command requests into one of a plurality of command tracking classifications to produce classification tagged command requests. The plurality of classification tagged command requests and corresponding plurality of command responses are communicated via a bus. Command classification tracking logic tracks the plurality of classification tagged command requests and a corresponding plurality of classification tagged command response to determine when there are no outstanding command requests associated with one of the plurality of command tracking classifications. There are no outstanding command requests associated with one of the plurality of command tracking classifications when the command classification tracking logic has received a number of classification tagged command responses equal to the number of sent classification tagged command requests associated with the same command tracking classification.

### FIELD OF THE INVENTION

The invention generally relates to buses in a computer system and more particularly to determining the status of bus requests and responses.

### BACKGROUND OF THE INVENTION

Computers are used in many applications and have evolved to include a plurality of input/output (I/O) devices generally interconnected with the central processing unit (CPU) via a chipset, or one or more bridge circuits. For example, the CPU of a computer system may be coupled directly to a chipset or bridge circuit comprising a northbridge and a southbridge. In some architectures, the northbridge handles communications between the CPU and, among other I/O devices, system memory and one or more graphics cards while the southbridge is responsible for supporting networking cards (e.g., an Ethernet card), hard drives, USB/FireWire-compatible devices, and the keyboard, mouse and similar devices compatible with serial ports.

A variety of standards have been developed to facilitate the above-mentioned connectivity. For instance, the Peripheral Component Interconnect (PCI) standard and the Accelerated Graphics Port (AGP) standard provide, among other things, a means for connecting I/O devices with the CPU. In the above example, PCI protocol employing one or more PCI buses and PCI slots might be exploited to connect one or more peripheral devices to the bridge circuit and CPU such as, but not limited to, a keyboard and mouse. Similarly, AGP protocol employing one or more AGP slots and buses may be used to support a graphics card. More recently, the PCI Express (PCIe) standard/protocol has been implemented to support faster data rates with a variety of I/O devices. In one embodiment, the PCIe bus and associated PCIe slot might be associated with the northbridge of the exemplary computer system described above to provide high-speed data transfer between the CPU and I/O devices. In short, computer systems are generally designed to employ one or more bridge circuits and one or more buses to connect to a variety of I/O devices. Each bus might have its own physical slot and protocol to facilitate data transfer at a variety of speeds.

Buses connecting one or more I/O devices may utilize pairs of commands to effectuate a variety of logical functions. For instance, an I/O device may use a command request to read data from a particular location in system memory. Alternatively, an I/O device may use a similar command request to write data to another location in system memory. In response thereto, a bridge circuit may return a command response that may contain, among other things, data retrieved from its corresponding request, acknowledgment data, and a plurality of identification data.

Computing systems may further utilize a bus, such as one of an AGP bus, PCIe bus or any other suitable data transfer bus, with protocol that support in-order and out-of-order return command responses. In either case, an I/O device issues a first command request and then a second command request via the bus where each command request has a corresponding command response. When systems employ in-order buses, the first command response will return before the second command response. In these systems, invalidation of cached translations must wait until the last outstanding transaction completes (i.e., when the last outstanding command response returns). When systems employ out-of-order buses, the command response associated with the second command request may return prior to the command response associated with the first command request. Without a tracking mechanism in a system employing an out-of-order bus, the I/O device cannot easily determine which command requests have been processed and which command requests are still outstanding.

The problem associated with not having a tracking mechanism to determine the status of bus requests and responses is exacerbated in modern computer systems employing CPUs that are capable of operating in a variety of contexts, each context requiring a separate assignment or allocation of physical memory locations (such as, for example, in system memory or any other suitable memory). As appreciated by one having ordinary skill in the art, a context corresponds to the environment in which the CPU is operating and may be determined, dictated or defined by the operating system or application(s) executing on the CPU at a given moment in time. In a first context, I/O devices connected to the CPU might be provided with one or more virtual to physical destination address translations that are deemed valid via one or more address translation requests and responses.

Each translation maps a given virtual destination address to a corresponding physical destination address. One of ordinary skill in the art will recognize that a given virtual to physical destination address translation request may “map” one or more of a plurality of virtual destination addresses to a corresponding plurality of physical destination addresses. It is further appreciated by one having ordinary skill in the art that one or more physical destination addresses may be associated with one or more virtual destination addresses.

The I/O devices may maintain a translation cache having entries, each containing one or more virtual to physical destination addresses for use in issuing command requests to the bridge circuit and CPU. After a context switch, for example from a first context to a second context, one or more virtual to physical destination address translations previously provided may be invalid. In other words, the translation cache may no longer be accurate.

A variety of prior art solutions address the problem associated with context switching. A first prior art solution requires the CPU to notify an I/O device that it desires to switch contexts. The notification takes the form of an invalidate request indicating, directly or indirectly, that one or more virtual to physical destination address translations will no longer be valid after the context switch. One of ordinary skill in the art will recognize that an invalid request may take the form of any suitable request. For example, the request may indicate that all physical destination addresses affiliated with a range of virtual destination addresses is invalid. Other suitable request formats are hereby contemplated.

Upon receipt of the invalidate request, an I/O device stops sending or issuing new command requests and waits for all corresponding command responses to return. Using a counter, the I/O device counts the number of outstanding command requests by incrementing the counter value for each sent command request and by decrementing the value for each received command response. When the counter reaches a threshold value such as, for example, zero, the I/O device instructs the CPU via an invalidate response to switch the context. At this point the I/O device can guarantee that no outstanding command requests or new command requests are associated with any virtual to physical destination address translations represented by information in the invalidate request. Communication using command requests and command responses resumes with one or more new translation requests for the new context. While this solution provides a viable option, the bus is underutilized during the waiting period and overall system performance is slow.

A second prior art solution associates a counter with each unique translation entry in the translation cache. I/O logic tags each command request with a plurality of tag bits representing its associated virtual to physical destination address translation. When a command request is sent via the bus, its associated counter is incremented to indicate that its associated command request is outstanding. Similar logic tags each command response with the plurality of tag bits associated with its corresponding command request such that upon receipt, the I/O device decrements the associated counter to indicate that the command request affiliated therewith is no longer outstanding.

Upon receipt of an invalidate request indicating, directly or indirectly, that one or more virtual to physical destination address translations will be invalid after the context switch, the I/O devices stops issuing command requests associated with any virtual to physical destination address translations identified, directly or indirectly, by the invalidate request. The I/O device identifies which counters are associated with the identified physical destination addresses and waits until each identified counter reaches a threshold value such as, for example, zero before the I/O device instructs the bridge circuit and CPU, via an invalidate response, to switch the context. At this point, the I/O device can guarantee that no outstanding command requests or new command requests are associated with the invalid virtual to physical destination address translations. While this solution is equally viable, it suffers from requiring a large number of counters and tag bits to accurately keep track of each physical destination address. For example, for a translation cache size having 256 unique translation entries, an equal number of counters must be maintained and at least 8 bits of tag data per command request are required.

Thus, a need exists for tracking bus command requests and responses that efficiently makes use of the bandwidth of the bus and that minimizes the use of expensive hardware and/or software counters and tag bits. A similar need exists for tracking bus command requests and responses such that I/O devices connected to a bridge circuit and CPU can quickly respond to invalidate requests indicative of a desired context switch. One of ordinary skill in the art will recognize that such a need applies to buses that support in-order and out-of-order return.

### BRIEF DESCRIPTION OF THE DRAWINGS

The invention will be more readily understood in view of the following description when accompanied by the below figures and wherein like reference numerals represent like elements:

FIG. 1 is a block diagram illustrating one example of a system for tracking bus command requests and command responses including, among other things, command handling logic and response classification logic in accordance with one embodiment of the present disclosure;

FIG. 2 is a flow chart illustrating one example of a method for tracking bus command requests and command responses in accordance with one embodiment of the present disclosure;

FIG. 3 is a flow chart illustrating one example of a method for storing tracking information to track each of the plurality of classification tagged command requests and each of the corresponding plurality of classification tagged command responses for each command tracking classification in accordance with the method of FIG. 2;

FIG. 4 is a flow chart illustrating one example of a method for producing a plurality of classification tagged command responses in accordance with the method of FIG. 2;

FIG. 5 is a block diagram illustrating one example of a system for tracking bus memory command requests and memory command responses including, among other things, an I/O device and a bridge circuit in accordance with one embodiment of the present disclosure;

FIG. 6 represents a first portion of a flow chart illustrating one example of a method for tracking bus memory command requests and memory command responses in accordance with one embodiment of the present disclosure;

FIG. 7 represents the second portion of a flow chart illustrating one example of a method for tracking bus memory command requests and memory command responses in accordance with the method of FIG. 6;

FIG. 8 is a block diagram illustrates one example of a classification tagged command request for use in, among other systems, the systems of FIGS. 1 and 5; and

FIG. 9 is a block diagram illustrates one example of a classification tagged command response for use in, among other systems, the systems of FIGS. 1 and 5.

### DETAILED DESCRIPTION OF THE PRESENT EMBODIMENTS

Generally, the present invention provides a method and apparatus for grouping a plurality of command requests into one of a plurality of command tracking classifications and tracking the plurality of command requests and a plurality of command responses on a per command tracking classification basis. By tracking the command requests and responses, the method and apparatus determines when there are no outstanding command requests associated with one of the plurality of command tracking classifications. By implementing such a method and apparatus, command requests and responses sent along a bus may be accurately tracked without using excessive amounts of additional hardware and/or software counters or tag bits but while making better use of the bandwidth over the bus.

In one embodiment, the method and apparatus tags each of the plurality of command requests with information representing a current command tracking classification. Each of the corresponding plurality of command responses are similarly tagged with the information contained in its associated command request. Thus, the number of outstanding command requests associated with each of the plurality of command tracking classifications may be easily tracked using command classification tracking logic. Upon determining that there are no outstanding command requests associated with one of the plurality of command tracking classifications, the identified command tracking classification becomes the new current command tracking classification. Thus, at any given time, only a single command tracking classification may be used to tag the plurality of command requests.

In another embodiment, the method and apparatus described above may be used to determine when a CPU may safely switch contexts. In other words, the method and apparatus may be adopted in a system employing a CPU, a bridge circuit and at least one I/O device where the CPU issues at least one invalidate request indicating that at least one virtual to physical destination address translation will be invalid upon a desired context switch. Thus it may be determined when an invalidate response may be issued by an I/O device instructing the bridge circuit/CPU that the proposed context switch can safely occur. The invalidate response indicates that no outstanding classification tagged memory command requests exist for any of the memory command tracking classifications associated with any virtual to physical destination addresses translations represented, directly or indirectly, in the invalidate request. In response to an invalidate response, a processor context may be switched.

As discussed below, limited additional memory resources are needed to support the method and apparatus described herein. Accordingly, the method and apparatus discussed herein solves the problems identified in the prior art solutions where, for example, either a large amount of counters or an inefficient use of bus bandwidth was required to track outstanding memory requests and issue invalidate responses.

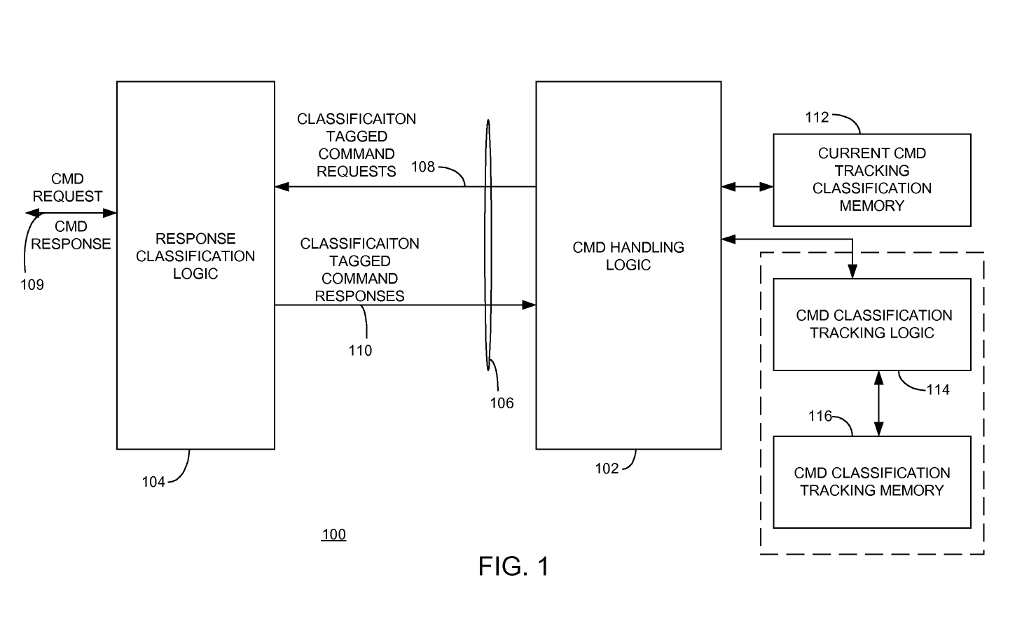

The present disclosure can be more fully described with reference to FIGS. 1-9. FIG. 1 is a block diagram illustrating one example of a system 100 for tracking bus command requests and command responses including, among other things, command handling logic 102 and response classification logic 104. As illustrated, command handling logic 102 is coupled to the response classification logic 104 via bus 106 where, in one embodiment, bus 106 is associated with a protocol that supports in-order command responses or out-of-order command responses. For example, bus 106 may correspond to an AGP bus, a PCI bus, a PCIe bus or any other suitable bus. Command handling logic 102 is also coupled to current command tracking classification memory 112 and to command classification tracking logic 114. Command classification tracking logic 114 is coupled to command classification tracking memory 116.

System 100 and the logic components listed therein may be manufactured with or composed of one or more integrated circuits (ICs), discrete logic devices, state machines, application specific integrated circuits (ASICs) or any other suitable structure or structures. Alternatively, the logic components of system 100 may be implemented in software as a plurality of executable instructions stored in suitable memory where the plurality of executable instructions may be executed by one or more suitable processors such as but not limited to any suitable distributed or non-distributed processing or microprocessing device. Executable instructions may be stored in any suitable memory device or devices. Suitable bus ports and interfaces may be affiliated with each of the command handling logic 102 and response classification logic 104 to support communication over bus 106. The above-mentioned memory components may be any suitable memory device or memory devices such as but not limited to volatile and non-volatile memory, random access memory (including, e.g., RAM, DRAM, SRAM), ROM-based memory (including, e.g., ROM, PROM, EPROM, EEPROM) and flash memory. In one embodiment, the logic components and memory described above may be affiliated with any computing system, set-top box, hand held device, printer or any other wired or wireless and stationary or mobile device that employs a bus capable of supporting in-order or out of order command responses, such as bus 106.

In operation, the command handling logic 102 receives a plurality of command requests from any suitable source (not shown) such as, for example, a client desiring access to one or more addressable memory locations associated with system 100. For instance, each of the plurality of command requests may be associated with a physical destination address that corresponds to an addressable memory location of system 100. One having ordinary skill in the art recognizes that one or more physical destination addresses may be associated with one or more command requests. The command handling logic 102 groups the plurality of command requests into one of a plurality of command tracking classifications by tagging each of the plurality of command requests with information representing the current command tracking classification to produce a corresponding plurality of classification tagged command requests 108.

The information representing the current command tracking classification is stored in the current command tracking classification memory 112. Generally, the plurality of command tracking classifications is used to establish a scheme to group each of the plurality of command requests. In one embodiment, the information representing the current command tracking classification and the information representing each of the plurality of command tracking classifications corresponds to any suitable data such as, for example, one or more bits that serve to “number” the groups of command requests. Thereupon, the command handling logic 102 sends each of the plurality of classification tagged command requests 108 via the bus 106.

The response classification logic 104 receives the plurality of classification tagged command requests 108 via bus 106 and, in response, may send the plurality of command requests associated with the plurality of classification tagged command requests 108 via any suitable command bus 109 to one or more corresponding physical destination addresses. In one embodiment, the plurality of command requests may be the plurality of classification tagged command requests 108. Alternatively, the command requests may correspond to the plurality of classification tagged command requests 108 without the information representing the tagged classification.

As illustrated, command bus 109 may also be used to transmit a corresponding plurality of command responses, each corresponding to one of the sent command requests, to the response classification logic 104. In one embodiment, each of the plurality of command responses transmitted via command bus 109 may include information requested and read from a suitable memory location designated by the physical destination address in a corresponding command request. Alternatively, each of the plurality of command responses may include an acknowledgment that a corresponding command request was successfully processed. While the command bus 109 is illustrated as a single bi-directional bus, it is contemplated that command bus 109 may be any suitable unidirectional or bi-directional link or links coupling the response classification logic 104 with one or more corresponding physical destination addresses.

In one embodiment, upon receipt of the plurality of command responses via command bus 109, the response classification logic 104 tags each of the plurality of command responses with information representing the command tracking classification associated with the corresponding classification tagged command request 108 to produce a plurality of classification tagged command responses 110. As illustrated, the response classification logic 104 sends the plurality of classification tagged command responses 110 via bus 106 where it is received at command handling logic 102.

In one embodiment, where command requests correspond to the plurality of classification tagged command requests 108 without the information representing the tagged classification, response classification logic 104 includes memory (not shown), such as one or more buffers or any other suitable memory to store each command tracking classification for each of the plurality of classification tagged command requests 108. In return, response classification logic 104 uses the memory (not shown) to track each of the classification tagged command requests 108 and each of the command requests and command responses sent over bus 109 and tags each of the plurality of command responses sent over bus 109 with information representing the command tracking classification associated with the corresponding classification tagged command request 108 to produce the plurality of classification tagged command responses 110.

In one embodiment, bus 106 allows out-of-order command responses, or more appropriately stated, out-of-order classification tagged command responses 110. That is, the plurality of classification tagged command responses 110 might not be presented in the same order as the corresponding plurality of classification tagged command requests. Command classification tracking logic 114 responsively tracks the plurality of classification tagged command requests 108 and the corresponding plurality of classification tagged command responses 110 on a per command tracking classification basis to determine when there are no outstanding command requests associated with one of the plurality of command tracking classifications. There are no outstanding command requests associated with an identified command tracking classification when the command handling logic 102 has received a number of classification tagged command responses 110 tagged with a command tracking classification equal to the number of sent classification tagged command requests 108 tagged with the same classification.

In connection therewith, the command classification tracking memory 116 stores tracking information to track each of the plurality of classification tagged command requests 108 and each of the corresponding plurality of classification tagged command responses 110 for each command tracking classification. In one embodiment, the command classification tracking memory 116 stores tracking information representing a number of outstanding classification tagged command requests associated with the current command tracking classification in response to each classification tagged command request 108 sent via the bus 106. Similarly, command classification tracking memory 116, in response to each of the plurality of classification tagged command responses 110 received via the bus 106, stores tracking information representing the number of outstanding classification tagged command requests associated with the command tracking classification included in each of the plurality of classification tagged command responses 110.

In one embodiment, the command handling logic 102 sends any suitable information to the command classification tracking logic 114 indicating the command tracking classification for each of the plurality of classification tagged command requests 108 sent and for each of the plurality of classification tagged command responses 110 received via bus 106. In response, the command classification tracking logic 114, in conjunction with the command classification tracking memory 116, acts like a plurality of counters for each of the command tracking classifications. For example, upon notification that one of the plurality of classification tagged command requests 108 was sent via the bus 106, the command classification tracking logic 114 reads tracking information representing the current number of outstanding classification tagged command requests associated with the applicable command tracking classification (i.e., the current command tracking classification) stored in the command classification tracking memory 116. Thereupon, the command classification tracking logic 114 generates updated tracking information representing an increase in the number of outstanding classification tagged command requests for that command tracking classification. In response thereto, the command classification tracking memory 116 stores the updated tracking information for the applicable command tracking classification. Upon notification that one of the plurality of classification tagged command responses 110 was received via the bus 106, the same process repeats with the exception that the updated tracking information represents a decrease in the number of outstanding classification tagged command requests for the applicable command tracking classification.

Command handling logic 102 determines when there are no outstanding classification tagged command requests associated with one of the plurality of command tracking classifications based on the stored tracking information in the command classification tracking memory 116. In one embodiment, the command handling logic 102 continuously monitors the stored tracking information in the command classification memory 116 to determine when there are no outstanding classification tagged command requests associated with any of the plurality of command tracking classifications. In another embodiment, the command classification tracking logic 114 continuously monitors the stored tracking information in the command classification memory 116 and notifies the command handling logic 102 when there are no outstanding classification tagged command requests associated with any of the plurality of command tracking classifications. In one embodiment, the stored tracking information in the command classification tracking memory 116 indicates that there are no outstanding classification tagged command requests associated with one of the plurality of command tracking classifications when the stored tracking information associated with the one of the plurality of command tracking classifications represents a threshold value, such as, for example, zero.

Upon determining that there are no outstanding classification tagged command requests associated with the one of the plurality of command tracking classifications, the command handling logic 102 generates updated information representing the command tracking classification having no outstanding tagged command requests and transmits it to the current command tracking classification memory 112. Thereupon, the current command tracking classification memory 112 stores the updated information as stored information representing the current command tracking classification. At this point, any subsequent command requests tagged are tagged with the updated current command tracking classification.

As demonstrated in the above discussion, at any given time, only one of the plurality of command tracking classifications, identified as the current command tracking classification, is open. Command requests tagged at this time may only be tagged or assigned to the currently open classification. A classification, once closed, may not be re-opened for assignment until it is determined that no outstanding classification tagged command requests exists for that classification.

In the above description, the term “tagging” has been used to suggest that the command handling logic 102 and the response classification logic 104 is capable of adding or altering information to a command request and command response, respectively, thereby forming classification tagged command requests and classification tagged command responses. As one having ordinary skill in the art will recognize, tag fields are generally already used in prior art buses. In one embodiment, tagging may include the manner in which the command handling logic 102 and the response classification logic 104 is capable of using one or more unused tag bits in a given tag field, thereby generating classification tagged command requests and classification tagged command responses.

In yet another embodiment, the term “tagging” refers to the method in which the command handling logic 102 and the response classification logic 104 each employ a suitable memory device or devices (not shown) that may be used as look-up table or tables. In this embodiment, the command handling logic 102 and its related memory device or devices may store data representing the command tracking classification for each classification tagged command request 108 where the command tracking classification is indexed by any suitable parameter. One having ordinary skill in the art will recognize that a parameter may include one or more bits of data. For example, the parameter may include one or more bits of the pre-existing tag field. In return, the classification tagged command request 108 is send over bus 106 with the suitable parameter. After transmission over the bus 106, the response classification logic 104 and its related memory device or devices may similarly store each classification tagged command request 108 and its related parameter similar to the manner described above.

It is further apparent to one of ordinary skill in the art, that any combination of the above described structures and methodologies may be employed to effectively tag each command request and command response.

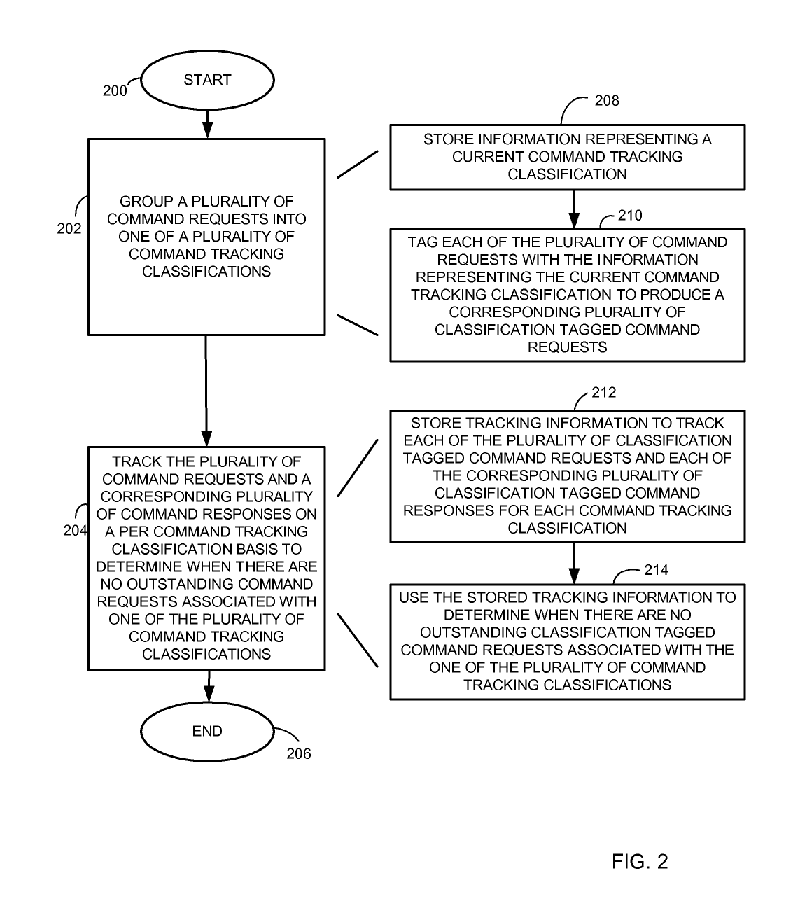

FIG. 2 is a flow chart illustrating one example of a method for tracking bus command requests and command responses in accordance with one embodiment of the present disclosure. The method begins in block 200 where a plurality of command requests are received. In one example, the command handling logic 102 of FIG. 1 receives a plurality of command requests from any suitable source. The method continues in block 202 where the plurality of command requests are grouped into one of a plurality of command tracking classifications as described in block 202. In one embodiment, the grouping of the plurality of command requests includes the storing of information representing a current command tracking classification as indicated in block 208. Each of the plurality of command requests is then tagged, in block 210, with the information representing the current command tracking classification to produce a corresponding plurality of classification tagged command requests. For purposes of illustration, the command handling logic 102 and current command tracking classification memory 112 of FIG. 1 may be utilized as described above to implement the method of blocks 202 and 208-210.

Thereafter, the method continues in block 204 where the plurality of command requests and a corresponding plurality of command responses are tracked on a per command tracking classification basis to determine when there are no outstanding command requests associated with one of the plurality of command tracking classifications. In one embodiment, the method of block 204 may be implemented by storing tracking information to track each of the plurality of classification tagged command requests and each of the corresponding plurality of classification tagged command responses for each command tracking classification as indicated in block 212. Thereafter, the stored tracking information is used in block 214 to determine when there are no outstanding classification tagged command requests associated with the one of the plurality of command tracking classifications. For purposes of illustration, the command handling logic 102 and the command classification tracking logic 114 and command classification tracking memory 116 of FIG. 1 may be utilized as described above to implement the method of blocks 204 and 212-214. Lastly, the method concludes in block 206, where for example, in one embodiment, the stored information representing the current command tracking classification is updated with information representing the command tracking classification having no outstanding classification tagged command requests.

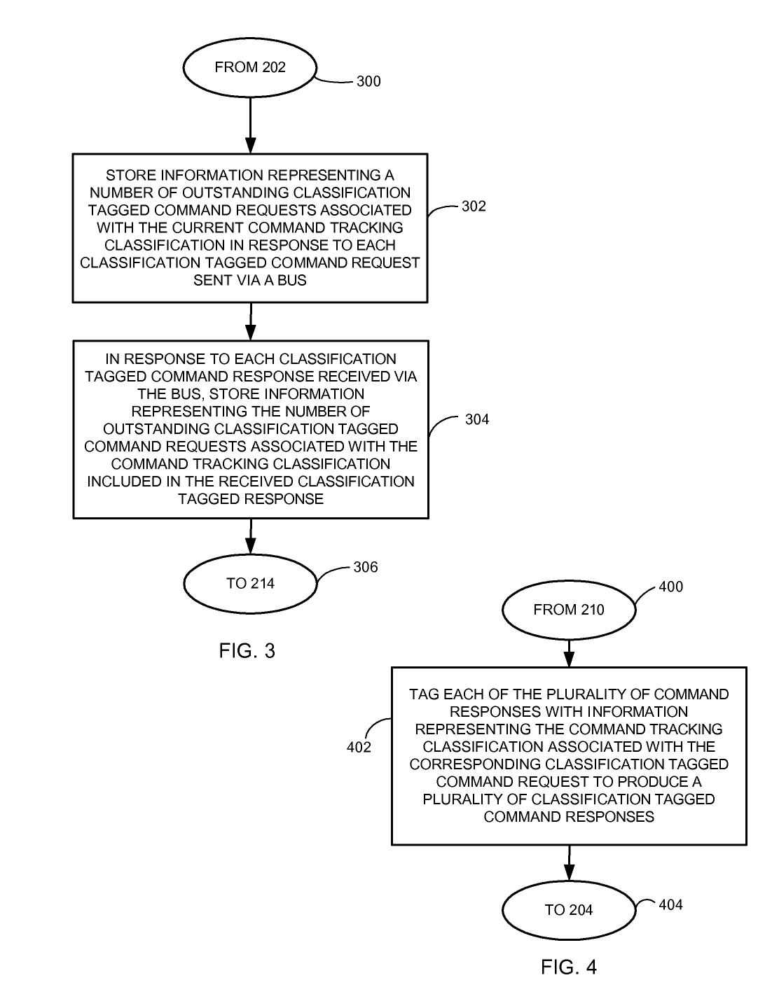

FIG. 3 is a flow chart illustrating one example of a method for storing tracking information to track each of the plurality of classification tagged command requests and each of the corresponding plurality of classification tagged command responses for each command tracking classification in accordance with block 212 of FIG. 2. The method begins in block 300 where the plurality of command requests are grouped into one of a plurality of command tracking classifications. Continuing with block 302 the method includes storing information representing a number of outstanding classification tagged command requests associated with the current command tracking classification in response to each classification tagged command request sent via a bus. In response to each classification tagged command response received via the bus, the method continues in block 304 by storing information representing the number of outstanding classification tagged command requests associated with the command tracking classification included in the received classification tagged response.

For purposes of illustration, the methods of blocks 302 and 304 may be implemented, in one embodiment, using the command classification tracking logic 114 and the command classification tracking memory 116 as described above with respect to FIG. 1. The method concludes in block 306 where, in one embodiment, the stored tracking information is used as provided in block 214 of FIG. 2 to determine when there are no outstanding classification tagged command requests associated with the one of the plurality of command tracking classifications.

FIG. 4 is a flow chart illustrating one example of a method for producing a plurality of classification tagged command responses in accordance with FIG. 2. The method begins with block 400 where, in one embodiment, each of the plurality of command requests are tagged with the information representing the current command tracking classification to produce a corresponding plurality of classification tagged command requests as provided in block 210 of FIG. 2. The method continues in block 402 where each of the plurality of command responses are tagged with information representing the command tracking classification associated with the corresponding classification tagged command request to produce a plurality of classification tagged command responses. For purposes of illustration, the method of block 402 may be implemented, in one embodiment, using the response classification logic 104 as described above with respect to FIG. 1. Lastly, the method concludes in block 404 where, in one embodiment, the plurality of command requests and a corresponding plurality of command responses are tracked as provided in block 204 in FIG. 2.

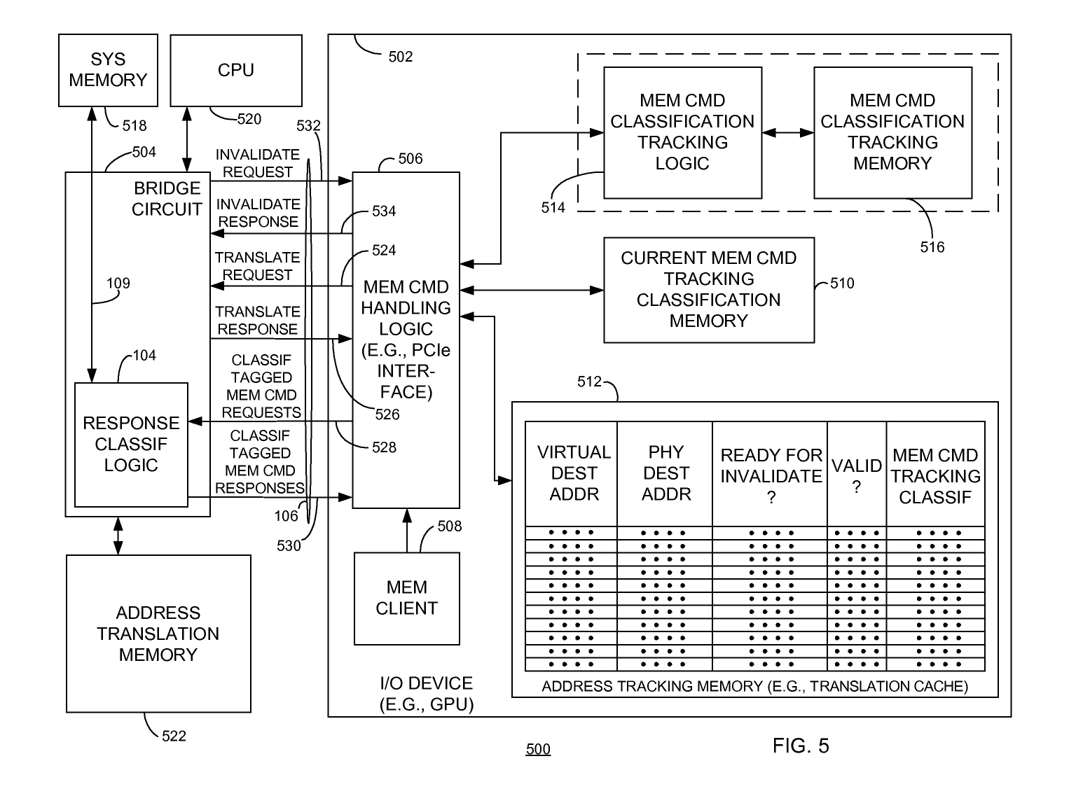

FIG. 5 is a block diagram illustrating one example of a system 500 for tracking bus memory command requests and memory command responses including, among other things, an I/O device 502 and a bridge circuit 504 in accordance with one embodiment of the present disclosure. I/O device 502 includes memory command handling logic 506 coupled to one or more memory clients 508, current memory command tracking classification memory 510, address tracking memory 512 and memory command classification logic 514. Although illustrated internal to the I/O device 502, the one or more memory clients 508 may also be located external to the I/O device 502. Memory command classification logic 514 is coupled to memory command classification tracking memory 516. Memory command handling logic 506 is coupled via bus 106 to the bridge circuit 504 which includes response classification logic 104. In one embodiment, bus 106 has a protocol that supports classification tagged memory command responses. As illustrated, bridge circuit 504 is coupled to system memory 518, central processing unit (CPU) 520 and address translation table memory 522.

System 500 and the logic components therein may be manufactured with or composed of one or more integrated circuits (ICs), discrete logic devices, state machines, application specific integrated circuits (ASICs) or any other suitable structure or structures. Alternatively, the logic components of system 500 may be implemented in software as a plurality of executable instructions stored in suitable memory where the plurality of executable instructions may be executed by one or more suitable processors such as but not limited to any suitable distributed or non-distributed processing or microprocessing device. Executable instructions may be stored in any suitable memory device or devices, such as but not limited to system memory 518. Suitable bus ports and interfaces may be affiliated with each of the memory command handling logic 506 and bridge circuit 504 to support communication over bus 106. The above-mentioned memory components may be any suitable memory device or memory devices such as but not limited to volatile and non-volatile memory, random access memory (including, e.g., RAM, DRAM, SRAM), ROM-based memory (including, e.g., ROM, PROM, EPROM, EEPROM) and flash memory. In one embodiment, the logic components and memory described above may be affiliated with any computing system, set-top box, hand held device, printer or any other wired or wireless and stationary or mobile device that employs a bus capable of supporting out of order command responses, such as bus 106.

In operation, memory command handling logic 506 receives a plurality of memory command requests from at least one of the one or more memory clients 508 or any other suitable source wherein each of the plurality of memory command requests is associated with a virtual destination address. In one embodiment, the memory command handling logic 506 references the address tracking memory 512 for each of the plurality of memory command requests to determine whether the virtual destination address was previously translated into a physical destination address. The address translation address 512 may correspond to any suitable memory and in one embodiment is a cache storing information with respect to each of a plurality of memory command requests. For purposes of illustration, address tracking memory 512 is depicted as a fully associative cache. As depicted, the corresponding information may include a virtual destination address, a physical destination address, an indicator representing whether the virtual to physical destination address translation is ready to be invalidated, a validity indicator and a memory command tracking classification. However, one of ordinary skill in the art will recognize that address tracking memory 512 may further be implemented as a look-up table or any other suitable memory. It is further appreciated that the addresses stored therein may correspond to partial addresses (i.e., address ranges).

If it is determined that the address tracking memory 512 already contains information representing a valid physical destination address corresponding to the virtual destination address, a new address translation request is not necessary. However, if it is determined that the address tracking memory 512 does not contain information representing a valid physical destination address corresponding to the virtual destination address, the memory command handling logic 506 sends a translate request 524 via bus 106 or any other suitable bus coupling the memory command handling logic 506 with the bridge circuit 504. Upon receipt of the translate request 524, the bridge circuit 504 references the address translation table memory 522 to translate the virtual destination address associated with the memory command request into a valid physical destination address. In one embodiment, the physical destination addresses stored within the address translation table memory 522 are generated or determined by the CPU 520 based on the context in which it is operating.

In response to the translation, the bridge circuit 504 returns the translated physical destination address in a translate response 526 transmitted via bus 106 or any other suitable bus. Upon determining the appropriate physical destination address for a given virtual destination address, the address tracking memory 512 stores information representing the translated physical destination address and the corresponding virtual destination address (i.e., stores the virtual to physical destination address translation). In addition, the address tracking memory 512 stores information representing that the physical destination address is valid and may be used while the CPU 520 continues to operate in the present context.

The memory command handling logic 506 interacts with the current memory command tracking classification memory 510 in the same manner as the command handling logic 102 interacted with the current command tracking classification memory 112 as described above with respect to FIG. 1. That is, the current memory command tracking classification memory 510 stores the current memory command tracking classification and the memory command handling logic 506 groups each of the plurality of memory command requests into one of the plurality of memory command tracking classifications by tagging each of the plurality of memory command requests with information representing the current memory command tracking classification to produce a corresponding plurality of classification tagged memory command requests 528. After each of the plurality of memory command requests is tagged by the memory command handling logic 506, the memory command logic 506 provides information to the address tracking memory 512 representing which memory command tracking classification was used to tag each classification tagged memory command request 528. In response thereto, the address tracking memory 512 stores the information such that it is associated with the proper entry corresponding to the virtual to physical destination address translation used by the particular memory command request.

As the memory command handling logic 506 continues to produce each of the plurality of classification tagged memory command requests 528 from the corresponding plurality of memory command requests, the bridge circuit 504, and more specifically the response classification logic 104 receives each of the plurality of classification tagged memory command requests 528 sent via bus 106. The response classification logic 104 operates in the same manner provided above with respect to the system 100 of FIG. 1. As illustrated in FIG. 5, the response classification logic 104 is coupled to system memory 518 as an example of memory having an addressable physical destination address each of the classification tagged memory command requests includes. However, it is contemplated that other types of memory associated with system 500 and not shown in FIG. 5 may be utilized to provide one or more addressable physical destination addresses. Response classification logic 104 also operates in the same manner as described above to produce the classification tagged memory command responses 530 and sends the classification tagged memory command responses 530 to the memory command handling logic 506 via bus 106.

As the plurality of classification tagged memory command requests 528 and the plurality of classification tagged memory command responses 530 are sent and received via bus 106, the memory command classification tracking logic 514 and memory command classification tracking memory 516 interact with the memory command handling logic 506 in the same manner as the command classification tracking logic 114 and the command classification tracking memory 116 interacted with the command handling logic 102 of FIG. 1. That is, the memory command classification tracking logic 514 tracks each of the plurality of classification tagged memory command requests 528 and each of the corresponding plurality of classification tagged memory command responses 530 to determine when there are no outstanding classification tagged memory command requests associated with one of the plurality of memory command tracking classifications.

When the memory command handling logic 506 determines that there are no outstanding classification tagged memory command requests associated with one of the plurality of memory command tracking classifications, the memory command handling logic 506 interacts with address tracking memory 512 by referencing all virtual to physical destination address translations that are associated with stored information representing the memory command tracking classification determined to have no outstanding classification tagged memory command requests. For each identified virtual to physical destination address translation, the address tracking memory 512 stores information indicating that the virtual to physical destination address translation can be invalidated as illustrated, for example, by the column labeled “READY FOR INVALIDATE” in the address tracking memory 512.

As discussed above with respect to the prior art, a CPU such as CPU 520 issues an invalidate request 532 via bridge circuit 504 and bus 106 or any other suitable bus coupling the CPU 520 or the bridge circuit 504 to the memory command logic 506 when it desires to change contexts. The invalidate request 532 contains information representing, directly or indirectly, a request to invalidate one or more virtual to physical destination address translations. As appreciated by one having ordinary skill in the art, the invalidate request 582 may be any suitable request, query or indicator or any other suitable signal, flag or information. In one embodiment, the invalidate request 532 may indicate a desire to invalidate, directly or indirectly, at least one physical destination address associated with at least one virtual destination address. Upon receipt of the invalidate request 532, the memory command handling logic 506 stops sending or producing any classification tagged memory command requests 528 associated with the one or more virtual to physical destination address translations represented in the invalidate request 532.

The memory command handling logic 506 sends an invalidate response 534 in response to determining that there are no outstanding classification tagged memory command requests associated with the one or more virtual to physical destination address translations represented in the invalidate request 532. In one embodiment, the memory command handling logic 506 references the address tracking memory 502 and sends the invalidate response 504 in response to determining that each of the one or more virtual to physical destination address translations represented in the invalidate request 532 can be invalidated. For example, the memory command handling logic 506 may reference all virtual to physical destination address translations stored in the address tracking memory 512 that are represented in the invalidate request 532 and determine whether each is associated with information indicating that the virtual to physical destination address translation can be invalidated. When each of the identified/referenced virtual to physical destination addresses translations can be invalidated, the memory command handling logic 506 sends an invalidate response 534 indicating that the CPU 520 or any other suitable processor can safely change contexts without causing the I/O device 502 or the CPU 520 to function improperly.

Additionally, when the invalidate response 534 is sent via bus 106 or any other suitable bus, the memory command handling logic 506 may also interface with the address tracking memory 512 such that the address tracking memory 512 stores information, for each of the one or more virtual to physical destination address translations represented in the invalidate request, indicating that the translation is invalid. For subsequent memory command requests associated with an invalid virtual to physical destination address translation stored in the address tracking memory 512, a new address translation is required.

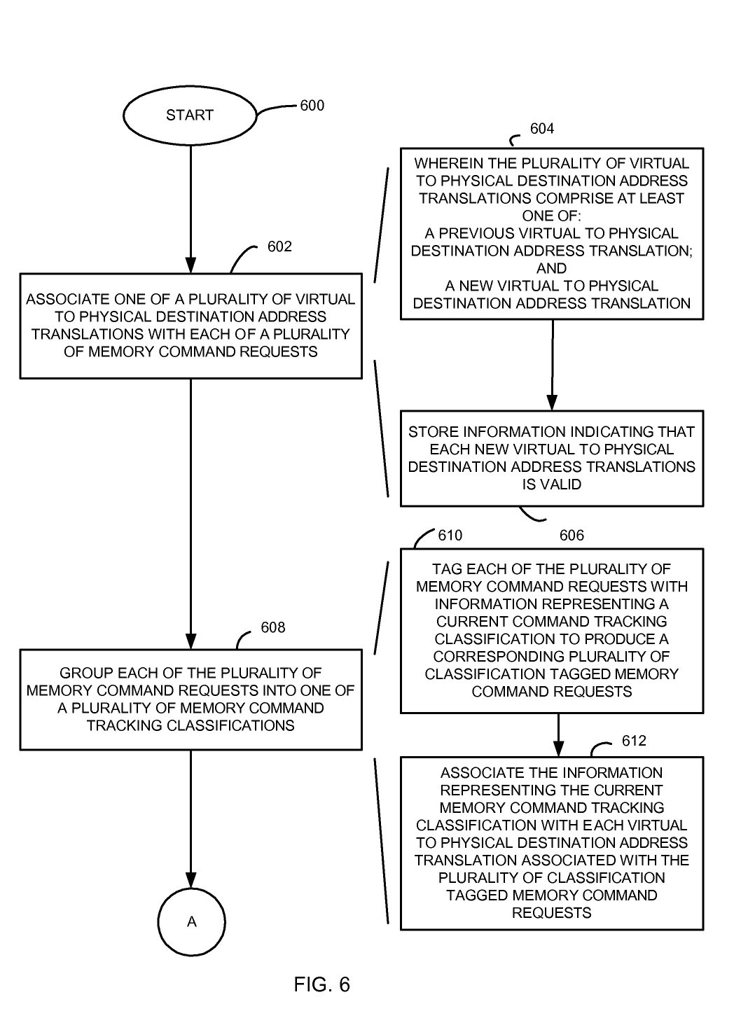

FIG. 6 represents a first portion of a flow chart illustrating one example of a method for tracking bus memory command requests and memory command responses in accordance with one embodiment of the present disclosure. The method begins in block 600 where, for example, a plurality of memory command requests are received, each of the plurality of memory command requests including at least one of a virtual destination address or a physical destination address. The method continues, in one embodiment, in block 602, where one of a plurality of virtual to physical destination address translations is associated with each of the plurality of memory command requests. In one embodiment, the plurality of virtual to physical destination address translations comprises at least one of: a previous virtual to physical destination address translation and a new virtual to physical destination address translation as illustrated in block 604. The method continues in block 606 where information indicating that each new virtual to physical destination address translation is valid is stored.

The method continues in block 608 where each of the plurality of memory command requests is grouped into one of a plurality of memory command tracking classifications. In one embodiment, each of the plurality of memory command requests are tagged, as provided in block 610, with information representing a current command tracking classification to produce a corresponding plurality of classification tagged memory command requests. The method continues in block 612 where the information representing the current memory command tracking classification is associated with each virtual to physical destination address translation associated with each of the plurality of classification tagged memory command requests.

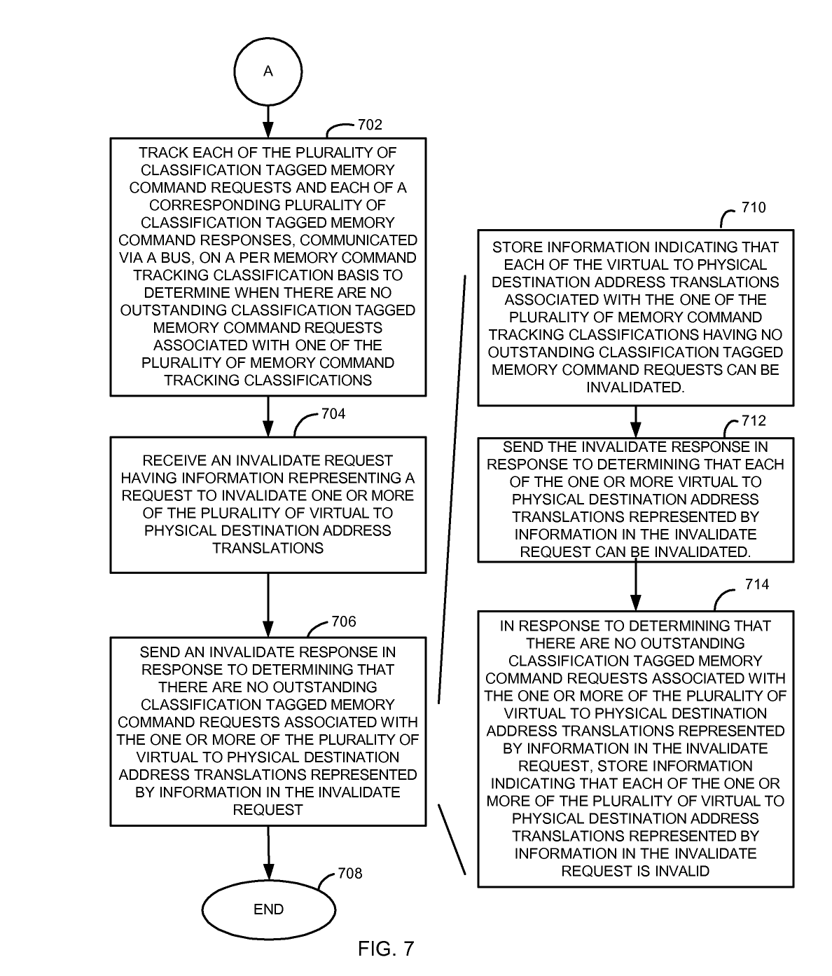

As indicated by the reference A in FIGS. 6-7, the method continues in FIG. 7 with block 702 in the same manner provided above with respect to block 204 of FIG. 2. The method continues in block 704 where an invalidate request having information representing a request to invalidate one or more virtual to physical destination address translations is received. Next, the method proceeds in block 706 where an invalidate request is sent in response to determining that there are no outstanding classification tagged memory command requests associated with the one or more of the plurality of virtual to physical destination address translations represented by information in the invalidate request.

In one embodiment, block 706 includes the methods of blocks 710-712. In block 710, information is stored indicating that each of the virtual to physical destination address translations associated with the one of the plurality of memory command tracking classification having no outstanding classification tagged memory command requests can be invalidated. Next, the invalidate response is sent in response to determining that each of the one or more virtual to physical destination address translations represented by information in the invalidate request can be invalidated as illustrated in block 712. Lastly, the method may further include, in response to determining that there are no outstanding classification tagged memory command requests associated with the one or more of the plurality of virtual to physical destination address translations represented by information in the invalidate request, storing information indicating that each of the one or more of the plurality of virtual to physical destination address translations represented by information in the invalidate request is invalid.

The method ends in block 708 where, for example, a new plurality of memory command requests are received. For the purposes of example, the methods of FIGS. 6-7 may be implemented using the various components described above with respect to system 500 in FIG. 5.

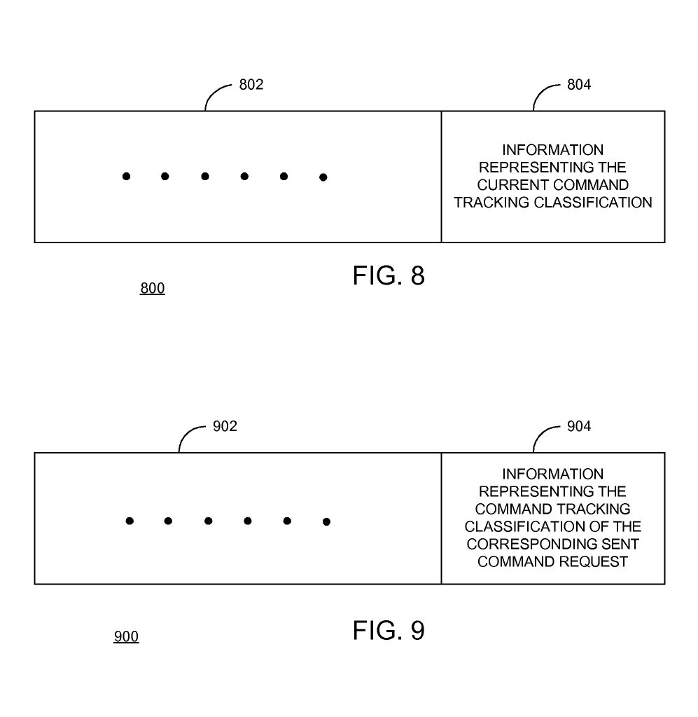

FIG. 8 is a block diagram illustrates one example of a classification tagged command request 800 for use in, for example, systems 100 and 500 of FIGS. 1 and 5. For instance, the structure identified as classification tagged command request 800 may be used as one of the plurality of classification tagged command requests 108 or as one of the plurality of classification tagged memory command requests 528. As illustrated a first portion 802 of the classification tagged command request 800 may correspond to information representing a command request. A second portion 804 of the classification tagged command request 800 may correspond to information representing the command tracking classification in which the command request was tagged. At the moment the command request is tagged, the second portion 804 of the classification tagged command request 800 represents the current command tracking classification.

Similarly, FIG. 9 is a block diagram illustrates one example of a classification tagged command response 900 for use in, for example, systems 100 and 500 of FIGS. 1 and 5. For instance, the structure identified as classification tagged command response 900 may be used as one of the plurality of classification tagged command responses 110 or as one of the plurality of classification tagged memory command responses 530. A first portion of the classification tagged command response 902 may correspond to information representing a command response. A second portion 904 may correspond to information representing the command tracking classification of the corresponding sent command request.

While the second portions 804 and 904 are illustrated as following the first portions 802 and 904 in FIGS. 8 and 9, respectively, it is contemplated that the second portions 804 and 904 may be any identifiable portion of the classification tagged command request 800 or response 900.

By tracking the classification tagged command requests 108 and corresponding classification tagged memory command responses 110 on a per command tracking classification basis, system 100 maximizes the use of bus 106 without employing a large amount of memory. Thus, the method and apparatus is easily adaptable to systems such as that disclosed in FIG. 5 where it is possible to track outstanding classification tagged memory command requests 528 to determine when an invalidate request 532 associated with a CPU 520 may issue instructing the CPU 520 that it may safely switch contexts. It is contemplated that the present disclosure be adaptable to both in-order and out-of-order buses, such as bus 106. One of ordinary skill in the art will recognize that when used in systems with an in-order bus, the present disclosure may be adapted to reduce the response time for sending an invalidate request when there is high latency (i.e., when there are many outstanding requests).

The above detailed description of the invention and the examples described therein have been presented for the purposes of illustration and description only and not by limitation. It is therefore contemplated that the present invention cover any and all modifications, variations, or equivalents that fall in the spirit and scope of the basic underlying principles disclosed above and claimed herein. For instance, while the above embodiments have been described with respect storing, providing or otherwise handling information representing or indicating various values, addresses, etc., it is contemplated that the information representing or indicating a value, address or otherwise, may be the value or address itself, or any other suitable information. Additionally, it is contemplated that the response classification logic 104 may be implemented in the command handling logic 102 or the memory command handling logic 506 such that the plurality of command responses are sent via the bus 106 while the plurality of classification tagged command responses 110 and the plurality of classification tagged command responses 530 are produced by the command handling logic 102 or the memory command handling logic 506. Lastly, it is contemplated that the method and apparatus described with respect to FIGS. 1-4 may be utilized in any system, such as system 100, to determine the status of bus requests and responses, and is not limited to use with context switching or address translation.

What is claimed is:

1. A method comprising:
grouping a plurality of command requests into one of a plurality of command tracking classifications; and
tracking the plurality of command requests and a corresponding plurality of command responses on a per command tracking classification basis.

2. The method of claim 1 further comprises determining when there are no outstanding command requests associated with one of the plurality of command tracking classifications.

3. The method of claim 1 wherein grouping the plurality of command requests into one of a plurality of command tracking classifications comprises:
storing information representing a current command tracking classification; and
tagging each of the plurality of command requests with the information representing the current command tracking classification to produce a corresponding plurality of classification tagged command requests.

4. The method of claim 3 wherein tracking the plurality of command requests and corresponding command responses comprises:
storing tracking information to track each of the plurality of classification tagged command requests and each of the corresponding plurality of classification tagged command responses for each command tracking classification; and
using the stored tracking information to determine when there are no outstanding classification tagged command requests associated with one of the plurality of command tracking classifications.

5. The method of claim 4 comprising, when it is determined that there are no outstanding corresponding classification tagged command requests associated with the one of the plurality of command tracking classifications, updating the stored information representing the current command tracking classification with information representing the command tracking classification having no outstanding classification tagged command requests.

6. The method of claim 4, wherein storing tracking information comprises:
storing tracking information representing a number of outstanding classification tagged command requests associated with the current command tracking classification in response to each of the plurality of classification tagged command requests sent via a bus; and
in response to each of the plurality of classification tagged command responses received via the bus, storing tracking information representing the number of outstanding classification tagged command requests associated with the command tracking classification included in the received classification tagged response.

7. The method of claim 3, further comprising tagging each of the plurality of command responses with information representing the command tracking classification associated with the corresponding classification tagged command request to produce a plurality of classification tagged command responses.

8. An apparatus comprising:
command handling logic operative to group a plurality of command requests into one of a plurality of command tracking classifications; and
command classification tracking logic operatively coupled to the command handling logic and operative to track the plurality of command requests and a corresponding plurality of command responses on a per command tracking classification basis.

9. The apparatus of claim 8 wherein the command classification tracking logic is further operative to determine when there are no outstanding command requests associated with one of the plurality of command tracking classifications.

10. The apparatus of claim 8, further comprising:
current command tracking classification memory operatively coupled to the command handling logic and operative to store information representing a current command tracking classification; and
wherein the command handling logic is operative to tag each of the plurality of command requests with the information representing the current command tracking classification to produce a corresponding plurality of classification tagged command requests.

11. The apparatus of claim 10, further comprising:
command classification tracking memory operatively coupled to the command classification tracking logic and operative to store tracking information to track each of the plurality of classification tagged command requests and each of the corresponding plurality of classification tagged command responses for each command tracking classification; and
wherein the command handling logic is further operative to determine when there are no outstanding classification tagged command requests associated with one of the plurality of command tracking classifications based on the stored tracking information.

12. The apparatus of claim 11 wherein:
the command handling logic is further operative to generate updated information representing the command tracking classification having no outstanding classification tagged command requests; and
the current command tracking classification memory is further operative to store the updated information as stored information representing the current command tracking classification.

13. The apparatus of claim 11, wherein the command classification tracking memory is further operative to:
store tracking information representing a number of outstanding classification tagged command requests associated with the current command tracking classification in response to each of the plurality of classification tagged command requests sent via a bus; and
in response to each of the plurality of classification tagged command responses received via the bus, store tracking information representing the number of outstanding classification tagged command requests associated with the command tracking classification included in the received classification tagged response.

14. The apparatus of claim 10, further comprising response classification logic operatively coupled to the command handling logic via at least a bus, wherein the response classification logic is operative to tag each of the plurality of command responses with information representing the command tracking classification associated with the corresponding classification tagged command request to produce a plurality of classification tagged command responses.

15. A method comprising:
associating one of a plurality of virtual to physical destination address translations with each of a plurality of memory command requests;
grouping each of the plurality of memory command requests into one of a plurality of memory command tracking classifications by:
tagging each of the plurality of memory command requests with information representing a current memory command tracking classification to produce a corresponding plurality of classification tagged memory command requests; and
associating the information representing the current memory command tracking classification with each of the associated virtual to physical destination address translations associated with the tagged plurality of memory command requests;
receiving an invalidate request having information representing a request to invalidate one or more of the plurality of virtual to physical destination address translations; and
sending an invalidate response in response to determining that there are no outstanding classification tagged memory command requests associated with the one or more of the plurality of virtual to physical destination address translations represented by information in the invalidate request.

16. The method of claim 15, wherein the plurality of virtual to physical destination address translations comprise at least one of:
a previous virtual to physical destination address translation; and
a new virtual to physical destination address translation; and
storing information indicating that each new virtual to physical destination address translations is valid.

17. The method of claim 15, further comprising tracking each of the plurality of classification tagged memory command requests and each of a corresponding plurality of classification tagged memory command responses, communicated via a bus, on a per memory command tracking classification basis to determine when there are no outstanding classification tagged memory command requests associated with one of the plurality of memory command tracking classifications.

18. The method of claim 17 further comprising storing information indicating that each of the virtual to physical destination address translations associated with the one of the plurality of memory command tracking classifications having no outstanding classification tagged memory command requests can be invalidated.

19. The method of claim 18, wherein the invalidate response is sent in response to determining that each of the one or more virtual to physical destination address translations represented by information in the invalidate request can be invalidated.

20. The method of claim 15, wherein,
in response to determining that there are no outstanding classification tagged memory command requests associated with the one or more of the plurality of virtual to physical destination address translations represented by information in the invalidate request, the method further comprises storing information indicating that each of the one or more of the plurality of virtual to physical destination address translations represented by information in the invalidate request is invalid.

21. An apparatus comprising:
address tracking memory operative to associate one of a plurality of virtual to physical destination address translations with each of a plurality of memory command requests;
current memory command tracking classification memory operative to store information representing a current memory command tracking classification;
memory command handling logic operatively coupled to the current memory command tracking classification memory and operative to group each of the plurality of memory command requests into one of a plurality of memory command tracking classifications by tagging each of the plurality of memory command requests with the information representing the current memory command tracking classification to produce a corresponding plurality of classification tagged memory command requests, wherein the address tracking memory is further operative to associate the information representing the current memory tracking classification with each of the associated virtual to physical destination address translations associated with the plurality of classification tagged memory command requests; and
wherein the memory command handling logic is further operative to receive an invalidate request having information representing a request to invalidate one or more of the plurality of virtual to physical destination address translations, and to send an invalidate response in response to the determination that there are no outstanding classification tagged memory command requests associated with one or more virtual to physical destination address translations represented by information in the invalidate request.

22. The apparatus of claim 21, wherein the plurality of virtual to physical destination address translations comprise at least one of:
a previous virtual to physical destination address translation;
a new virtual to physical destination address translation; and
wherein the address tracking memory is further operative to store information indicating that each new virtual to physical destination address is valid.

23. The apparatus of claim 21, wherein:
the memory command handling logic is operatively coupled to a bus; and
the apparatus further comprises memory command classification tracking logic operatively coupled to the memory command handling logic and operative to track each of the plurality of classification tagged memory command requests and each of a corresponding plurality of classification tagged memory command responses, communicated via the bus, on a per memory command tracking classification basis to determine when there are no outstanding classification tagged memory command requests associated with one of the plurality of memory command tracking classifications.

24. The apparatus of claim 23, wherein the address tracking memory is further operative to store information indicating that each of the virtual to physical destination address translations associated with the one of the plurality of memory command tracking classifications having no outstanding classification tagged memory command requests can be invalidated.

25. The apparatus of claim 24, wherein the command memory handling logic is further operative to send the invalidate response in response to determining that each of the one or more virtual to physical destination address translations represented by information in the invalidate request can be invalidated.

26. The apparatus of claim 21, wherein the address tracking memory is further operative to, in response to determining that there are no outstanding classification tagged memory command requests associated with the one or more of the plurality of virtual to physical destination address translations represented by information in the invalidate request, store information indicating that each of the one or more of the plurality of virtual to physical destination address translations represented by information in the invalidate request is invalid.

27. An apparatus comprising:
response classification logic operative to receive a plurality of classification tagged command requests over a bus; and
wherein the response classification logic includes an indexable memory such that the response classification logic is operative to generate a plurality of classification tagged command responses, each classification tagged command response corresponding to one of the plurality of classification tagged command requests.

28. A method comprising:
receiving an invalidate request having information representing a request to invalidate one or more virtual to physical destination address translations and
switching a processor context in response to determining that there are no outstanding classification tagged memory command requests associated with the one or more virtual to physical destination address translations represented by information in the invalidate request.
